(19) United States
(12) Patent Application Publication
(10) Pub. No.: US 2014/0244468 A1
(43) Pub. Date: Aug. 28, 2014

(54) TRIGGERED BOND OR DEBT STRUCTURE SWAP

(71) Applicant: Ross P. Aron, New York, NY (US)

(72) Inventor: Ross P. Aron, New York, NY (US)

(21) Appl. No.: 13/935,697

(22) Filed: Jul. 5, 2013

Related U.S. Application Data
(60) Provisional application No. 61/769,306, filed on Feb. 26, 2013.

(51) Int. Cl. G06Q 40/04

(52) U.S. Cl. CPC G06Q 40/04
USPC 705/37

(57) ABSTRACT

Disclosed herein is a method that includes providing a contract between a first party and a second party, the contract including a triggering event associated with a first debt structure, and a right of the first party upon the occurrence of the triggering event to swap the first debt structure with a second debt structure. The method further includes determining, by a computer system, that the triggering event occurred and swapping, by the computer system, the first debt structure with the second debt structure.

### FIELD OF THE DISCLOSURE

The subject matter disclosed herein relates generally to a system and method for selling or purchasing bonds or other debt structures. More particularly, the subject matter relates to a system and method for trading bonds or other debt structures which include providing option rights with the original bond or other debt structure purchase.

### BACKGROUND

Personal financial investments may take any one or more of a number of forms. These forms are generally considered to represent their own “markets.” Well known investment markets include, for example, real estate (commercial and residential), deposit accounts (such as certificates of deposits), private businesses, commodities, and securities. Securities typically fall into “equity” and “debt” rights and obligations. Equity typically represents common stock in a public or private company and “debt” typically represents “bonds”, “notes” or “debentures.”

In addition to the issuance of bonds by public companies, the issuance of bonds has become an extensively used vehicle for raising funds by governmental or quasi-governmental entities or agencies. For example, bonds are typically issued by municipalities for general purposes or by quasi-government agencies such as a transportation agency, stadium authority, or utility, often for specific capital construction purposes. These municipal bonds typically contain terms and conditions by which the issuer agrees to return fixed amounts of the purchaser's initial investment to the purchaser (or transferee) at specified times, and potentially includes bond “interest” (generally known as a “coupon”). Municipal bonds also include either or both expiration and call dates at which the purchaser or transferee receives an agreed amount on redemption of the bond.

During their lives, bonds fluctuate in market value. This is a function of a number of factors which can either lead to and/or include fluctuations in demand. Fluctuations in demand are a function of several variables, which can include interest rate changes, bond liquidity/marketability, interest rate levels, credit quality of the issuer, general equity market changes, and bond rating, either internally by a company or by a rating agency (which generally reflects the ability of the bond issuer to pay the investor all expected payments). It has historically been observed that favorable equity market trends, rising interest rates, illiquid markets, lower credit quality of issuers, and lower ratings from either a rating agency or internal ratings from a company may reduce bond demand, and thus the value of the subject bond. The combination of bond value fluctuation, a bonds ratings uncertainty, a generally low interest rate environment, and the practical unavailability of bond insurance in the wake of the most recent (2007-2009) financial crisis has made the bond market largely unavailable to the typical personal investor.

Thus, a system and method for trading bonds or other similar debt structures which reduces or eliminates these impediments for the typical personal investor would be well received in the art.

### BRIEF DESCRIPTION

According to one aspect, a method comprises: providing a contract between a first party and a second party, the contract including: a triggering event associated with a first debt structure; and a right of the first party upon the occurrence of the triggering event to swap the first debt structure with a second debt structure; determining, by a computer system, that the triggering event occurred; and swapping, by the computer system, the first debt structure with the second debt structure.

According to another aspect, a computer program product, comprises a computer readable hardware storage device storing a computer readable program code, said computer readable program code comprising an algorithm that when executed by a computer processor of a computer system implements a method, said method comprising: analyzing, by the computer system, a contract, the contract including: a triggering event associated with a first debt structure; and a right to a first party upon the occurrence of the triggering event to swap the first debt structure with a second debt structure; determining, by the computer system that the triggering event occurred; and swapping, by the computer system, the first debt structure with the second debt structure.

According to yet another aspect, a computer system comprises a computer processor coupled to a computer-readable memory unit, said memory unit comprising instructions that when executed by the computer processor implements a method comprising: analyzing, by the computer system, a contract, the contract including: a triggering event associated with a first debt structure; and a right to a first party upon the occurrence of the triggering event to swap the first debt structure with a second debt structure; determining, by the computer system, that the triggering event occurred; and swapping, by the computer system, the first debt structure with the second debt structure.

According to still another aspect, a method comprises: providing a contract between a first party and a second party, the contract including: a triggering event associated with a first debt structure; and a right of the first party upon the occurrence of the triggering event to swap the first debt structure with a second structure; determining, by a computer system, that the triggering event occurred; swapping, by the computer system, the first debt structure with the second structure; and wherein the triggering event includes at least one of: (A) the death of the first party; (B) the diagnosis of terminal illness of the first party defined as a life expectancy of twelve months or less; (C) the diagnosis of a medical condition of the first party requiring extraordinary medical care or treatment regardless of life expectancy; (D) certification by a health care practitioner of any condition which requires continuous care for the remainder of the first party's life in an eligible facility or at home; (E) certification by a licensed health care practitioner that the first party is chronically ill; and (F) the first party's having been a resident of a nursing home for a period of three months or more with an expectation that such insured will remain a resident of a nursing home until death.

According to another aspect, a computer program product, comprises a computer readable hardware storage device storing a computer readable program code, said computer readable program code comprising an algorithm that when executed by a computer processor of a computer system implements a method, said method comprising: analyzing, by the computer system, a contract between a first party and a second party, the contract including: a triggering event associated with a first debt structure; and a right of the first party upon the occurrence of the triggering event to swap the first debt structure with a second structure; determining, by the computer system, that the triggering event occurred; swapping, by the computer system, the first debt structure with the second structure; and wherein the triggering event includes at least one of: (A) the death of the first party; (B) the diagnosis of terminal illness of the first party defined as a life expectancy of twelve months or less; (C) the diagnosis of a medical condition of the first party requiring extraordinary medical care or treatment regardless of life expectancy; (D) certification by a health care practitioner of any condition which requires continuous care for the remainder of the first party's life in an eligible facility or at home; (E) certification by a licensed health care practitioner that the first party is chronically ill; and (F) the first party's having been a resident of a nursing home for a period of three months or more with an expectation that such insured will remain a resident of a nursing home until death.

According to yet another aspect, a computer system comprises a computer processor coupled to a computer-readable memory unit, said memory unit comprising instructions that when executed by the computer processor implements a method comprising: analyzing, by the computer system, a contract between a first party and a second party, the contract including: a triggering event associated with a first debt structure; and a right of the first party upon the occurrence of the triggering event to swap the first debt structure with a second structure; determining that the triggering event occurred; and swapping, by the computer system, the first debt structure with the second structure; and wherein the triggering event includes at least one of: (A) the death of the first party; (B) the diagnosis of terminal illness of the first party defined as a life expectancy of twelve months or less; (C) the diagnosis of a medical condition of the first party requiring extraordinary medical care or treatment regardless of life expectancy; (D) certification by a health care practitioner of any condition which requires continuous care for the remainder of the first party's life in an eligible facility or at home; (E) certification by a licensed health care practitioner that the first party is chronically ill; and (F) the first party's having been a resident of a nursing home for a period of three months or more with an expectation that such insured will remain a resident of a nursing home until death.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a computer system in accordance with one embodiment;

FIG. 2 depicts a first flowchart of a method in accordance with one embodiment;

FIG. 3 depicts a second flowchart of a method in accordance with another embodiment;

FIG. 4 depicts a third flowchart of a method in accordance with another embodiment;

FIG. 5 depicts a fourth flowchart of a method in accordance with another embodiment;

FIG. 6 depicts a fifth flowchart of a method in accordance with another embodiment; and

FIG. 7 depicts a sixth flowchart of a method in accordance with another embodiment.

### DETAILED DESCRIPTION

A detailed description of the hereinafter described embodiments of the disclosed apparatus and method are presented herein by way of exemplification and not limitation with reference to the Figures.

Disclosed herein are systems and methods for performing bond or other debt structure transactions. In a first embodiment, the systems and methods for performing bond or other debt structure transactions may provide the right of a bond or other debt structure owner to exchange his bond or other debt structure for another bond or other debt structure under pre-agreed terms upon the occurrence of a pre-agreed event, the pre-agreed event hereinafter referred to as a “triggering event.” It should be understood that the term “triggering event” hereinafter may refer to a single event, or a combination of a plurality of events which may all occur. The bond or other debt structure transaction may be referred to hereinafter as a “triggered swap.” Pursuant to the triggered swap, in the sale and purchase of the bond or other debt structure, a buyer of the bond or other debt structure, hereinafter “the buyer” and a seller of the bond or other debt structure, hereinafter “the seller,” may agree that when the triggering event occurs, the buyer has the right to compel the triggered swap. By exercising their right to compel the triggered swap, the buyer may exchange the purchased bond or other debt structure for a second or alternate bond or structure, hereinafter the “exchange structure,” that was previously agreed upon at the original time of purchase of the contract between the buyer and a named exchange party, hereinafter “exchange party”, allowing the buyer to exchange bonds, hereinafter “swap contract”. It should be understood that the “buyer” may be referred to as a “first party” to a transaction in accordance with the methods and systems described herein. Similarly, either the seller or the exchange party may be referred to as a “second party.” Likewise, either the seller or the exchange party may also be referred to as a “third party” depending on the embodiment.

In the first embodiment, the buyer and the exchange party may agree that the exchange structure comprises a specifically identified bond or other debt structure, or may be selected from available bonds or other debt structures having agreed upon characteristics. The exchange structure may be a financial instrument whereby the triggered bond swap method and system may not be subject to the regulatory requirements applicable to insurance marketing and sales. The triggered swap methods and systems described herein may enable financial advisors to reduce the buyer's risk in exchange, for example, for agreed compensation upon entering the original purchase agreement with the seller. The employment of the triggered swap system and methods may thereby open the bond market (or markets for other debt structures) for retail investors or buyers. These triggered swap rights will be separated from the bond or other debt structure ownership so that the seller may transfer those rights to the exchange party.

In a second embodiment, a first debt structure such as a bond may be purchased by the first party. The first party may acquire certain rights which may be satisfied by the first party in the event that a triggering event occurs. However, unlike the first embodiment, the triggering event may specifically be: (A) the death of the first party; (B) the diagnosis of terminal illness defined as a life expectancy of twelve months or less; (C) the diagnosis of a medical condition requiring extraordinary medical care or treatment regardless of life expectancy; (D) certification by a licensed health care practitioner of any condition which requires continuous care for the remainder of the first party's life in an eligible facility or at home, for example, when the first party is chronically ill, or for example, as defined by Section 7702(B) of the Internal Revenue Code and regulations thereunder, provided the accelerated payments qualify under Section 101(g)(3) of the Internal Revenue Code and all other applicable sections of federal law in order to maintain favorable tax treatment; (E) certification by a licensed health care practitioner that the first party is chronically ill, for example, as defined by Section 7702 (B) of the Internal Revenue Code and regulations thereunder, provided the accelerated payments qualify under Section 101(g)(3) of the Internal Revenue Code and all other applicable sections of federal law in order to maintain favorable tax treatment and the insurer that issues such policy is a qualified long term care insurance carrier under Section 4980c of the Internal Revenue Code or provide a special surrender value, upon total and permanent disability of the insured, and optional modes of settlement of proceeds; or (F) the first party's having been a resident of a nursing home, for example, as defined in section twenty-eight hundred one of the public health law, for a period of three months or more, with an expectation that such insured will remain a resident of a nursing home until death.

In this second embodiment, upon one of these predetermined triggering events, the first party (or heirs) may exchange the first debt structure with a second structure. The second structure may be, for example, cash, a debt structure, an equity structure, or any other form of compensation described in the present disclosure. Thus, relative the first embodiment, the triggering event is more specifically limited to the death, paralysis or debilitating injury of the buyer. However, the rights acquired by the buyer which vest after the triggering event may not be limited to a debt structure swap (as in the first embodiment), and may instead allow the first party (or heirs) to collect be any form of compensation agreed upon by the first party (or heirs) and the seller or exchange party upon the agreement of the contract terms.

Hereinafter, it will be understood that the methods and systems for performing a bond or other debt structure transaction may be applicable to various types of debt structures. For example, municipal bonds including any traditional debt instrument issued by a municipality including general obligation bonds, revenue bonds, double-barreled bonds, moral obligation bonds, taxable municipal bonds, tax-backed bonds, transportation bonds, zero-coupon bonds, original issue discount bonds, pre-refunded bonds, escrow to maturity bonds, housing bonds, municipal notes, conduit bonds, higher education bonds, student loans, municipal housing, military housing, healthcare bonds, investor owned utilities, regulated utilities, pooled infrastructure, or infrastructure finance are contemplated. Moreover, corporate bonds including any debt security issued by a corporation including convertible bonds, callable bonds, puttable bonds, zero coupon bonds, investment grade bonds, high yield bonds, straight cash bonds, split-coupon bonds, payment-in-kind (PIK) bonds, floating rate and increasing rate notes (IRNs), extendable reset note bonds, deferred interest bonds, multi-tranche bonds, secured corporates, and junior or subordinated bonds are all contemplated. Still further, government bonds including treasury bills, treasury notes, treasury bonds, I-bonds, treasury inflation protection securities (TIPS), zero coupon bonds, series EE/E bonds, series HH/H bonds, government agency and quasi government agency (GSE) mortgage bonds (Fannie Mae/Freddie Mac), pass through notes and the like are contemplated. Still further, structured bonds such as guaranteed investment contracts (GICs), medium term notes, and investment agreements are contemplated.

The methods and systems for performing a bond or other debt structure transaction may be applicable to asset-backed securities including RMBS (home equity loans, prime and subprime mortgages, closed end second, etc.), consumer asset-backed bonds including auto loans, credit cards, student loans, equipment leases, auto leases, manufactured housing, small business loans, auto dealer inventory, trade receivables, commercial mortgage backed securities, all corporate asset backed bonds including operating assets, structured insurance securitizations, life settlements, franchise assets, future flow, aircraft portfolio leases and the like. Moreover, collateralized obligations such as collateralized debt obligations (CDO), CDO-squared, collateralized bond obligations (CBO), collateralized loan obligations (CLO), pooled corporate obligations (investment grade corporate pools), commercial real estate CDOs, structured CMBS pools, synthetic CDOs (managed or static pools), and high yield corporate CDOs are also contemplated. Equity and equity derivative instruments including common stock, ETFs, ADRs, preferred stock, convertible preferred stock, cumulative preferred stock, participating preferred stock, non-cumulative preferred stock, warrants, options, leaps, futures, single stock futures, forwards, rights, transferable subscription rights, swaps and convertible debentures are also contemplated for application with the systems and methods described herein.

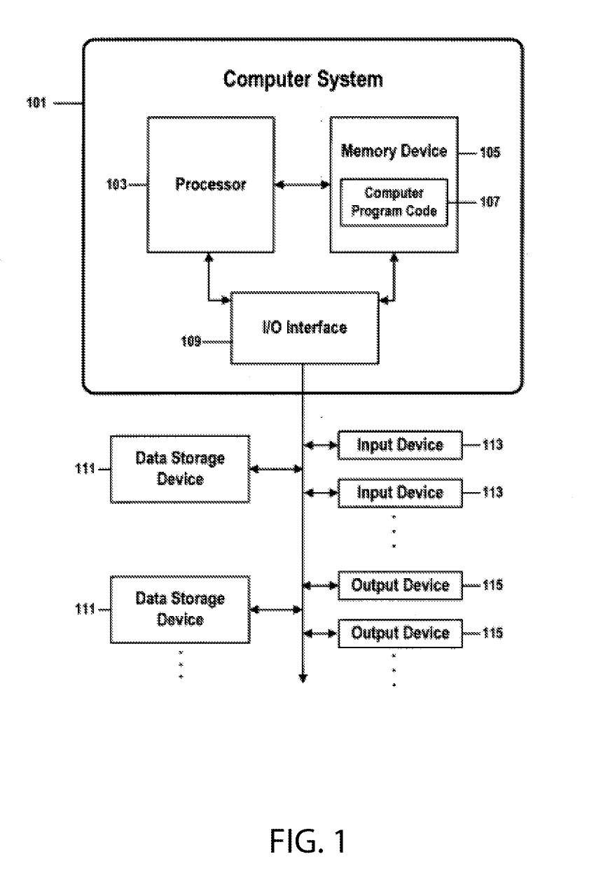

It should be understood that any or all of the steps taught in the present disclosure of the methods for performing the bond or other debt structure transaction described herein may be performable, for example, by a computer system 101 shown in FIG. 1. FIG. 1 shows the structure of a computer system and computer program code that may be used to implement a method for performing the bond transaction in accordance with the present disclosure. FIG. 1 refers to objects 101-115.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, in one embodiment, the present invention may take the form of a computer program product comprising one or more physically tangible (e.g., hardware) computer-readable medium(s) or devices having computer-readable program code stored therein, said program code configured to be executed by a processor of a computer system to implement the methods of the present invention. In one embodiment, the physically tangible computer readable medium(s) and/or device(s) (e.g., hardware media and/or devices) that store said program code, said program code implementing methods of the present invention, do not comprise a signal generally, or a transitory signal in particular.

Any combination of one or more computer-readable medium(s) or devices may be used. The computer-readable medium may be a computer-readable signal medium or a computer-readable storage medium. The computer-readable storage medium may be, for example, but is not limited to, an electronic, magnetic, optical, electromagnetic, infrared, or semiconductor system, apparatus, or device, or any suitable combination of the foregoing. More specific examples (a non-exhaustive list) of the computer-readable storage medium or device may include the following: an electrical connection, a portable computer diskette, a hard disk, a random access memory (RAM), a read-only memory (ROM), an erasable programmable read-only memory (EPROM or flash memory), Radio Frequency Identification tag, a portable compact disc read-only memory (CD-ROM), an optical storage device, a magnetic storage device, or any suitable combination of the foregoing. In the context of this document, a computer-readable storage medium may be any physically tangible medium or hardware device that can contain or store a program for use by or in connection with an instruction execution system, apparatus, or device.

A computer-readable signal medium may include a propagated data signal with computer-readable program code embodied therein, for example, a broadcast radio signal or digital data traveling through an Ethernet cable. Such a propagated signal may take any of a variety of forms, including, but not limited to, electro-magnetic signals, optical pulses, modulation of a carrier signal, or any combination thereof.

Program code embodied on a computer-readable medium may be transmitted using any appropriate medium, including but not limited to wireless communications media, optical fiber cable, electrically conductive cable, radio-frequency or infrared electromagnetic transmission, etc., or any suitable combination of the foregoing.

Computer program code for carrying out operations for aspects of the present invention may be written in any combination of one or more programming languages, including, but not limited to programming languages like Java, Smalltalk, and C++, and one or more scripting languages, including, but not limited to, scripting languages like JavaScript, Perl, and PHP. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN), a wide area network (WAN), an intranet, an extranet, or an enterprise network that may comprise combinations of LANs, WANs, intranets, and extranets, or the connection may be made to an external computer (for example, through the Internet using an Internet Service Provider).

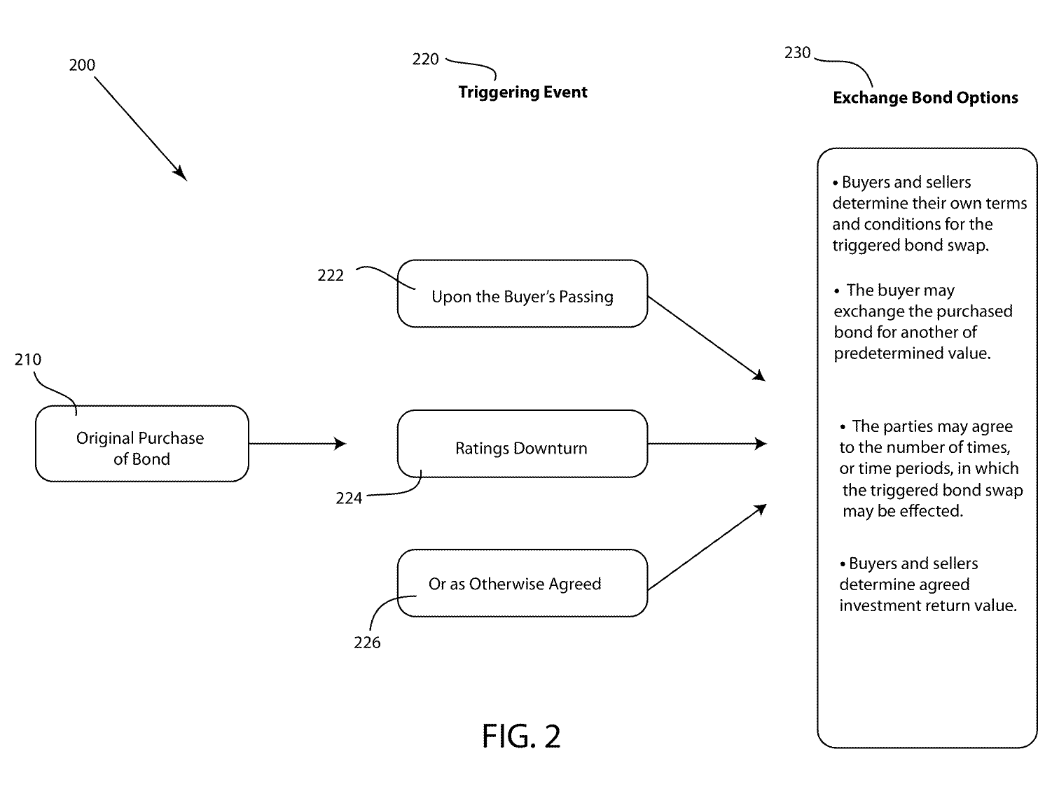

Aspects of the present invention are described above and below with reference to flowchart illustrations and/or block diagrams of methods, apparatus (systems) and computer program products according to embodiments of the present invention. It will be understood that each block of the flowchart illustrations, block diagrams, and combinations of blocks in the flowchart illustrations and/or block diagrams of FIGS. 2-6 can be implemented by computer program instructions. These computer program instructions may be provided to a processor of a general purpose computer, special purpose computer, or other programmable data-processing apparatus to produce a machine, such that the instructions, which execute via the processor of the computer or other programmable data-processing apparatus, create means for implementing the functions/acts specified in the flowchart and/or block diagram block or blocks.

These computer program instructions may also be stored in a computer-readable medium that can direct a computer, other programmable data-processing apparatus, or other devices to function in a particular manner, such that the instructions stored in the computer-readable medium produce an article of manufacture, including instructions that implement the function/act specified in the flowchart and/or block diagram block or blocks.

The computer program instructions may also be loaded onto a computer, other programmable data-processing apparatus, or other devices to cause a series of operational steps to be performed on the computer, other programmable apparatus, or other devices to produce a computer-implemented process such that the instructions that execute on the computer or other programmable apparatus provide processes for implementing the functions/acts specified in the flowchart and/or block diagram block or blocks.

The flowchart illustrations and/or block diagrams FIGS. 2-6 illustrate the architecture, functionality, and operation of possible implementations of systems, methods and computer program products according to various embodiments of the present invention. In this regard, each block in the flowchart or block diagrams may represent a module, segment, or portion of code, wherein the module, segment, or portion of code comprises one or more executable instructions for implementing one or more specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special-purpose hardware-based systems that perform the specified functions or acts, or combinations of special-purpose hardware and computer instructions.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for the efficient selection of runtime rules for programmable search in accordance with embodiments of the present invention, and may implement other embodiments described in this specification, including the methods illustrated in FIGS. 2-6. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for the efficient selection of runtime rules for programmable search.

Any of the components of the present invention could be created, integrated, hosted, maintained, deployed, managed, serviced, supported, etc. by a service provider who offers to facilitate a method for the efficient selection of runtime rules for programmable search. Thus the present invention discloses a process for deploying or integrating computing infrastructure, comprising integrating computer-readable code into the computer system 101, wherein the code in combination with the computer system 101 is capable of performing a method for the efficient selection of runtime rules for programmable search.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for executing the method for performing a bond transaction may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for executing the method for performing a bond transaction is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Shown in FIG. 2 is method of performing a triggered bond swap 200. It should be understood that the principles taught with respect to the method of performing the triggered bond swap 200 are also applicable to some or all of the debt structures described hereinabove. In the exemplary embodiment described in the Figures, the method 200 may include a contractual arrangement whereby in a first transaction, the buyer purchases an original bond 210 from the seller. This purchase may be offered, recorded, and the records may be stored by the computer system 101. In the original purchase of the bond at transaction 210, the buyer obtains rights from the exchange party to later exchange the bond for the exchange bond upon the occurrence of the triggering event. At step 220, the triggering event may occur. FIG. 2 shows three examples of triggering events. In one embodiment, the computer system 101 may determine that the triggering event occurs in light of input from a user, for example. The triggering event may be when the buyer dies 222, when the bond has a ratings move 224, or any other agreed upon event 226.

A ratings move 224 may be either an upgrade or a downgrade. For example, there are various nationally recognized statistical rating organizations (NRSROs) such as A.M. Best Company, Inc., DBRS Ltd., Egan-Jones Rating Company, Fitch, Inc., Japan Credit Rating Agency, Ltd., Kroll Bond Rating Agency, Inc. (f/k/a LACE Financial Corp.), Moody's Investors Service Inc., Rating and Investment Information Inc., Realpoint LLC., and Standard & Poor's Ratings Services. Any types of internal and external ratings by a company or entity or person, whether those ratings are calculated numerically or alphabetically, could be potential triggering events 220 in accordance with the present disclosure.

Other triggering events 226 may include when the market value of the bond or other debt structure drops to a predetermined level. This may be determinable by the computer system 101 in response to an input into the computer system 101 or other system updated ratings for bond levels. For example, a municipal bond may still be investment grade in terms of rating, but investors, who may be well ahead of the rating agencies, may have devalued the bond or other structure. Other events 226 may also include the loss of a job, the birth of a child, adoption, the death of a spouse, divorce, marriage, the change in the number of dependents, a debilitating injury, or retirement.

In still other embodiments, the event 226 may be that the bond does not output an agreed upon increased value to the buyer. This may provide assurance, in effect, that the buyer will receive a minimum agreed upon investment return from his bond. In this example, the agreed upon investment return for the bond may be a fixed value or may be derived by other market indices. For example, it may be agreed that the value of the exchange bond must at least equal the buyer's purchase price plus an amount equivalent to the accumulated interest applicable to an agreed form of certificate of deposit. This is may be a practical method to assure a buyer that his bond investment will at least provide the benefits that would have been derived from the purchase of a certificate of deposit.

The buyer of the bond may acquire rights from the seller shown in step 230 that are triggered by the triggering event. In a simple embodiment, the buyer may obtain rights to later exchange the bond for another bond of agreed characteristics or a predetermined value when the triggering event occurs at 220. In another embodiment, the buyer may obtain other rights such as an agreed minimum investment return value upon the triggering event occurring 220. These embodiments are not meant to be limiting, and the buyer and seller may determine their own terms and conditions for the triggered bond swap method 200.

In another embodiment, the buyer and the seller of the original bond purchase transaction may agree to the number of times, or time periods, in which the triggering event 220 may occur. This information may be recordable by the computer system 101. The computer system 101 may determine that the number of times has been exceeded and may not offer the rights to the buyer upon the occurrence of the excessive triggering event. For example, it may be agreed that if a triggering event occurs once, the exchange method 200 will occur, but if it occurs more than once, the exchange method 200 will not occur. Moreover, it should be understood that the rights acquired by the buyer may come at the price of consideration given by the buyer to the seller. For example, the buyer may pay a flat fee for one or more of the rights from the seller described in step 230, or the buyer may pay an ongoing fee of an agreed upon amount. In yet another embodiment, the buyer and the seller may agree that the

Still further, it should be understood that the triggered bond swap 200 may be executed by the computer system 101 described hereinabove. For example, the computer system 101 may be configured to determine when the triggering event occurs at step 210. The computer system 101 may further be configured to notify the buyer and/or seller of the bond that the triggering event occurred. The computer system 101 may be configured to automatically exchange the purchased bond with the exchange bond after the triggering event occurs. The computer system 101 may be configured to determine which exchange bond to replace the purchased bond with once the triggering event occurs. The computer system 101 may be configured to determine whether the number of triggering events have exceeded an agreed upon value. In other words, all the aspects of the methods described herein may be performable, facilitated, executed, and/or displayed by the computer system 101 and/or components of the computer system 101.

For example, an individual investor may purchase a municipal bond with the purpose of funding a child's education. The bond may include swapping rights 230 that occur when a tuition payment is due (the triggering event 222). The bond may have a reduced value at the time of the child's tuition is due. In this embodiment, the triggering event 226 may that the tuition is due and that the bond has a reduced value at this time. Thus, at this point, the buyer may be able to swap their reduced value bond with a different bond. In another example, if a husband and wife are going through a divorce when a bond value held by each is down. The triggering event may be the combination of the reduced bond value with the divorce. Replacing the bond with another bond may be an option if agreed upon at the original time of purchase. This may help the husband and wife (buyers) during the asset splitting phase of the divorce.

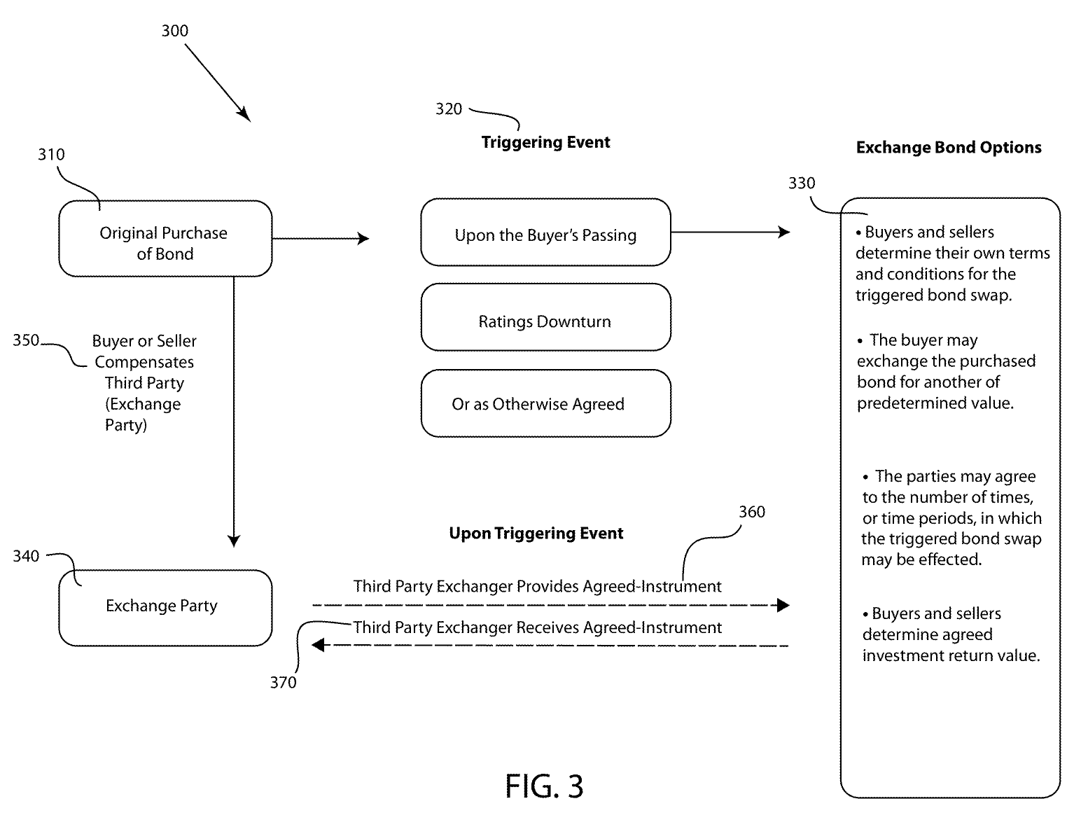

Another method of performing a triggered bond swap 300 is shown in FIG. 3. Like the method 200, the principles taught with respect to the method of performing the triggered bond swap 300 are also applicable to some or all of the debt and equity structures described hereinabove. This embodiment may be similar to the embodiment described in FIG. 2, including a bond purchase step 310, a triggering event step 320, and an acquiring rights step 330. However, in the method of performing a triggered bond swap 300, a exchange party 340 may be included. The exchange party 340 may be compensated by either the buyer or the seller at transaction 350. The exchange party 340 thereafter may be responsible for performing the obligation to the buyer for the rights acquired in step 330 upon the occurrence of the triggering event at step 320. Thus, in the case that the agreed upon rights in step 330 provide the buyer with the opportunity to acquire an exchange bond (or other debt structure in the case that the method is executed with non-bond instruments). Thus, at transaction 360, the exchange party 340 may provide an agreed upon exchange bond to the buyer. The exchange party 340 may, at transaction 370, receive the originally purchased bond or instrument which occurred at step 310. It should be understood that transactions 360 and 370 may occur simultaneously. Moreover, the exchange party 340 transaction may be automatically performed by a computer system, such as the computer system 101. In other words, the buyer may access the option to purchase the rights associated with the triggering event on the computer system 101, and the computer system 101 may be configured to locate the exchange party 340. Alternately, the computer system 101 may be a server that is operated by the exchange party 340 which is accessible by the buyer in order to purchase the rights associated with the triggering event.

In this embodiment, it is possible for a separate market for these exchange bond option rights 330, whereby the exchange party exchanger 340 may be engaged in speculation on whether the triggering event will occur at step 320. This separate market may be fully computerized and automated, and operate like a stock market, or any other financial instrument market. If the triggering event 320 never occurs, the exchange party exchanger 340 will have been compensated by the buyer and seller at transaction 350 without ever having to satisfy any future rights. If, however, the triggering event occurs one or more times at a later date at 320, the exchange party exchanger 340 may be forced to provide the buyer with compensation through the satisfaction of the rights 330. This agreed upon compensation or satisfaction of rights may exceed the value of the original compensation received by the exchange party exchanger 340 at transaction 350.

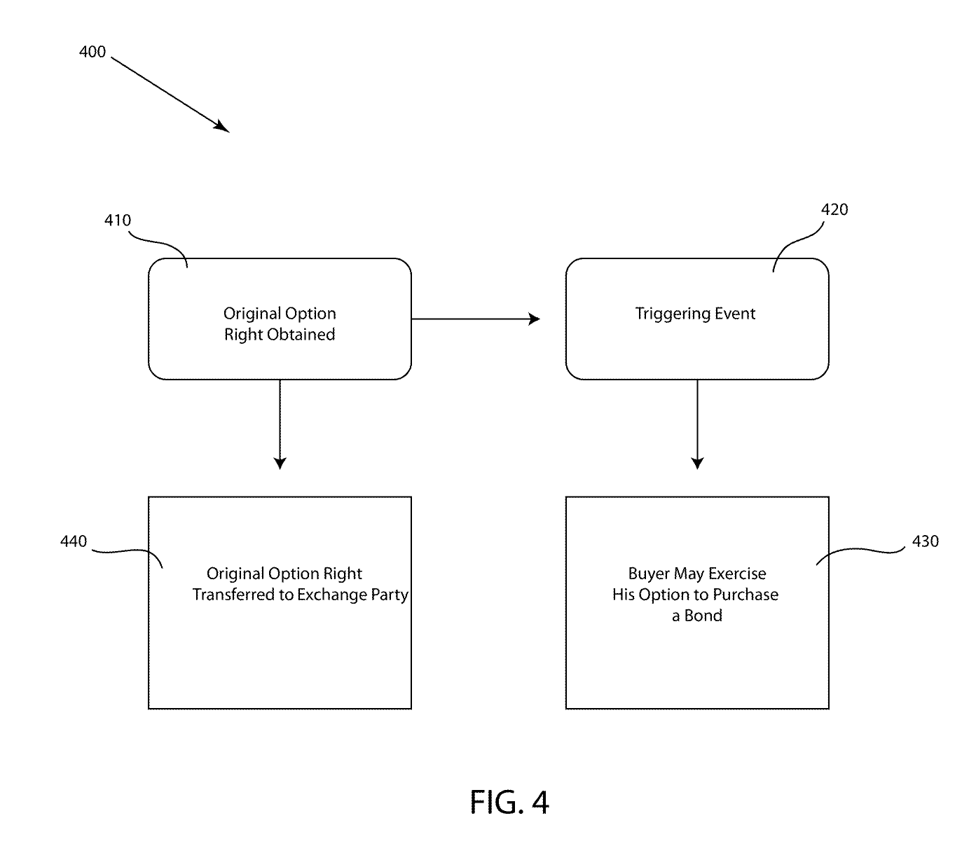

Another embodiment shown in FIG. 4, exemplifies an embodiment where the seller and buyer may not agree on an actual initial purchase with the initial transaction. Instead, the buyer may obtain an option right at the time of an initial transaction 410. This option right may be exercised at a transaction 430 after a triggering event 420 has occurred. This option right may, for example, allow the buyer to acquire a designated bond, or a bond having agreed upon characteristics, or a right to choose among bond or bond types. Alternately, the actual purchase may be delayed until the expiration of the agreement. In other words, the expiration of the agreement may be the triggering event 420. For example, in the case that the triggering event 420 is the death of the buyer, the purchase option may be delayed until the death of the buyer.

Like the method 300, the obligation to purchase the bond after the triggering event may be separated from the contractual relationship between the buyer and the seller and may be transferred to another exchange party exchanger during transaction 440 by the buyer or the seller. In such a transaction, the original transaction may provide compensation to the exchange party who would then absorb the risk of the occurrence of the triggering event. Thus, it is contemplated that a separate market for these option rights may exist.

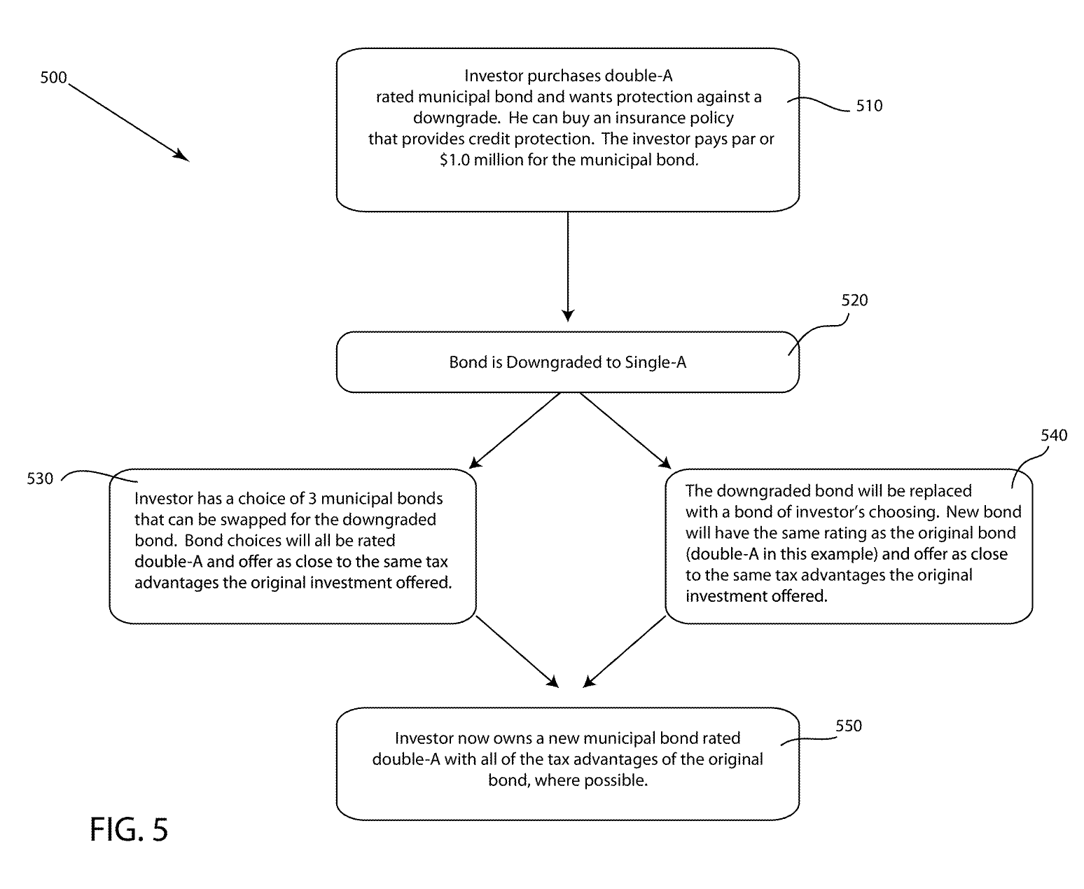

Another embodiment is shown in FIG. 5, which shows another method 500. The method 500 includes a first transaction step 510 in which an investor purchases a double A rated municipal bond and wants protection against a downgrade. At this transaction step 510, the investor buys an insurance policy that provides credit protection. The investor pays par or $1.0 million for the municipal bond. Then at step 520, the bond is downgraded to a single A rating. At this point in the exemplary method, two examples are shown. In a first example, shown at step 530, the investor may have a choice of 3 municipal bonds that may be swapped for the downgraded initially purchased bond. These bond choices may each be rated double A and may offer as close to the same tax advantages as the original investment bond. Although the swapped bond choices may be equal in rating to the first purchased bond, there may be embodiments where it is agreed that the exchange bond may have a better or worse rating than the originally purchased first bond. These principles apply to other debt structures as well as bonds.

In a second example, shown at step 540, the seller or exchange party exchanger may replace the downgraded bond with a bond of its choosing. Again, the new bond may be rated double A and offer as close to the same tax advantages as the original investment bond. Finally, at step 550, the investor now owns a new municipal bond rated double A with all of the tax advantages of the original bond wherever possible. The differences between step 530 and 540 may be negotiated or discussed at the time of the purchase of the credit protection of the bond investment.

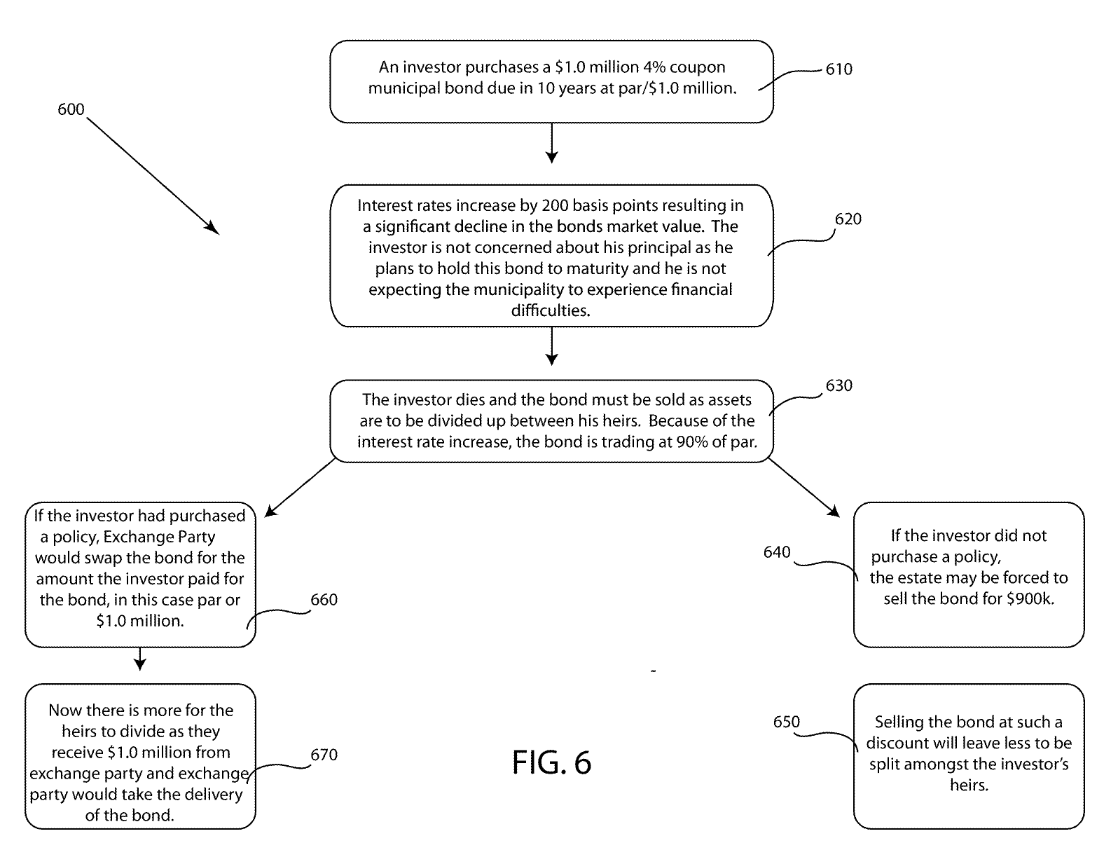

Still another embodiment is shown in FIG. 6, which shows another method 600. The method 600 may first include a transaction step 610 whereby an investor purchasing a $1.0 million, 4% coupon municipal bond due in 10 years at par/$1.0 million. At event step 620, interest rates increase by 200 basis points resulting in a significant decline in the bonds market value. The investor, however, may not be concerned about his principal as he may plan to hold this bond to maturity and he may not be expecting the municipality to experience financial difficulties. At event step 630, however, the investor dies and the bond must be sold as assets are to be divided up between his heirs. Because of the interest rate increase, the bond is trading at 90% of par at that time. At this point, the embodiment in FIG. 6 shows two examples. In a first example, the investor purchased an insurance policy whereby the seller or exchange party exchanger would swap the bond, at step 660, for the amount the investor paid for the bond, in this case the $1.0 million par value. The heirs would therefore receive the full $1.0 million at step 670 rather than the $900,000 they would have received. In a second example, the investor did not purchase an insurance policy on his investment. In this case the estate is forced to sell the bond for $900,000 at step 640, and distribute this reduced amount to the heirs at step 650.

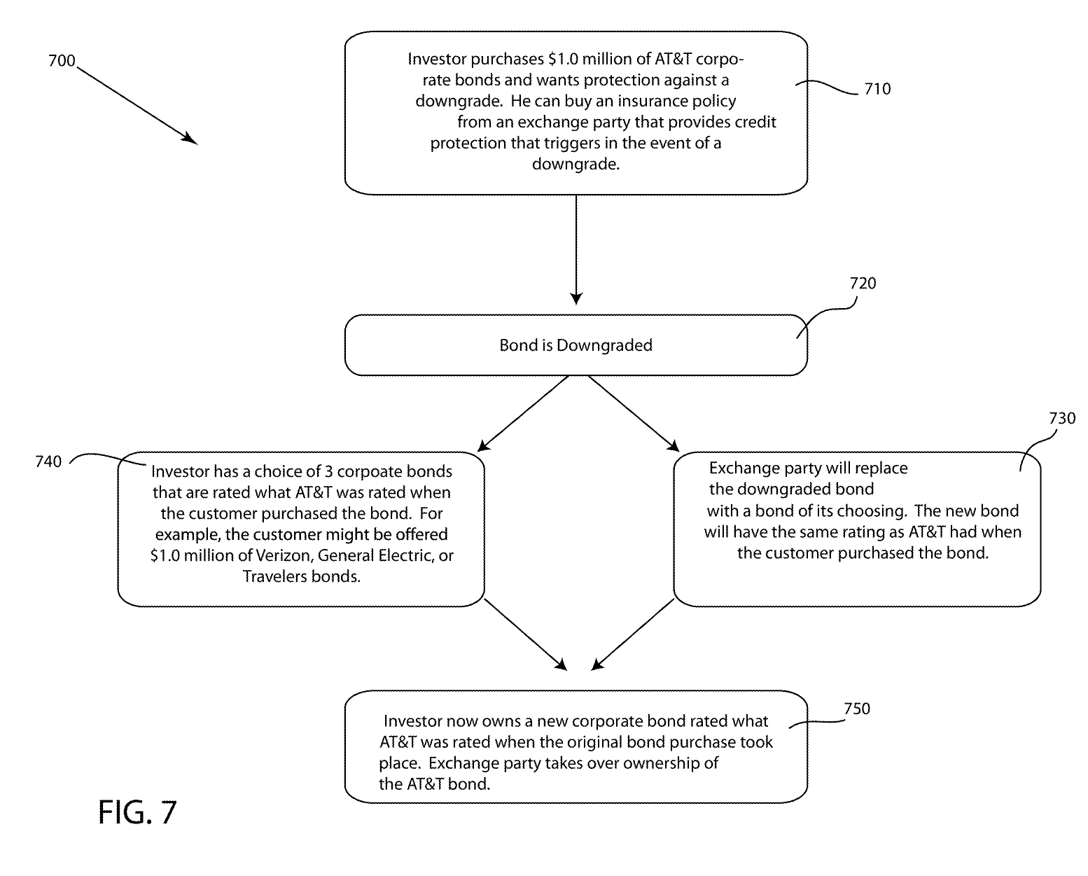

In a final exemplary embodiment shown in FIG. 7, a method 700 is shown. In this method 700, an investor purchases $1.0 million of AT&T corporate bonds at step 710 and wants protection against a bond downgrade. The investor buys a policy from a seller of exchange party exchanger that provides credit protection which is triggered in the event of a downgrade. At event step 720, the bond is downgraded. At this point, the investor may, at step 740 be offered three corporate bonds which are rated what the AT&T bonds were rated when the customer purchased them. For example, the customer might be offered $1.0 million of Verizon, General Electric, or Travelers bonds. Alternately, the seller or exchange party exchanger could replace the downgraded bond at step 730 with a bond of their choosing, which may be rated the same as the originally purchased AT&T bonds at the time of purchase. The investor now owns new corporate bonds, potentially rated what AT&T was rated when the original bond purchase took place and the seller or exchange party exchanger takes over ownership of the originally purchased AT&T bond.

Overall, the methods 200, 300, 400, 500, 600, 700 described herein may each include a step of providing a contract between a buyer and seller, the contract including: a first debt structure purchased by a buyer from a seller, a triggering event associated with the first debt structure and a right of the buyer upon the occurrence of the triggering event to swap the first debt structure with a second structure. The methods 200, 300, 400, 500, 600, 700 may each include analyzing, by a computer processor of a computer system, the contract. Additionally, the methods 200, 300, 400, 500, 600, 700 may include determining, by the computer processor, that the triggering event occurred. Moreover, the methods 200, 300, 400, 500, 600, 700 may each include swapping, by the computer processor, the first debt structure with the second structure. Still further, the methods may include offering, by the computer processor, a choice of bonds or structures to the buyer to choose from to become the second structure or bond.

Moreover, the methods may include providing a contract between a first party and a second party, the contract including: a triggering event associated with a first debt structure; and a right of the first party upon the occurrence of the triggering event to swap the first debt structure with a second structure. The method may include determining, by a computer system, that the triggering event occurred and swapping, by the computer system, the first debt structure with the second structure. In this embodiment, the triggering event may include at least one of: (A) the death of the first party; (B) the diagnosis of terminal illness of the first party defined as a life expectancy of twelve months or less; (C) the diagnosis of a medical condition of the first party requiring extraordinary medical care or treatment regardless of life expectancy; (D) certification by a health care practitioner of any condition which requires continuous care for the remainder of the first party's life in an eligible facility or at home; (E) certification by a licensed health care practitioner that the first party is chronically ill; and (F) the first party's having been a resident of a nursing home for a period of three months or more with an expectation that such insured will remain a resident of a nursing home until death.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

We claim:

1. A method comprising:
providing a contract between a first party and a second party, the contract including:
a triggering event associated with a first debt structure; and
a right of the first party upon the occurrence of the triggering event to swap the first debt structure with a second debt structure;
determining, by a computer system, that the triggering event occurred; and
swapping, by the computer system, the first debt structure with the second debt structure.

2. The method of claim 1, wherein the first debt structure is a first bond and wherein the second debt structure is a second bond.

3. The method of claim 2, wherein the triggering event is a change in a rating of the first bond, and wherein the second bond has the rating of the first bond prior to the change in the rating of the first bond.

4. The method of claim 3, further comprising offering, by the computer system, a choice of bonds to the first party to choose from to become the second bond.

5. The method of claim 2, wherein the triggering event is the death of the first party and the value of the first bond at the time of death being less than a predetermined value, and wherein the second debt structure has a value amounting to at least the predetermined value.

6. The method of claim 1, wherein the triggering event is an event selected from the group consisting of:
a rating change of the first debt structure;
the death of the first party;
a reduction in value of the first debt structure to a predetermined value; and
a lack of increase in value of the first debt structure over time from the date of the contract being executed.

7. The method of claim 1, wherein the first party is a buyer and wherein the second party is not a seller of the first debt structure, further comprising separating the right of the buyer from the first debt structure such that the contract is owned by neither the buyer nor the seller.

8. The method of claim 1, wherein the triggering event occurs at least partially at the discretion of the buyer.

9. The method of claim 1, wherein the second party is an original seller of the first debt structure.

10. A computer program product, comprising a computer readable hardware storage device storing a computer readable program code, said computer readable program code comprising an algorithm that when executed by a computer processor of a computer system implements a method, said method comprising:
analyzing, by the computer system, a contract, the contract including:
a triggering event associated with a first debt structure; and
a right to a first party upon the occurrence of the triggering event to swap the first debt structure with a second debt structure;
determining, by the computer system that the triggering event occurred; and
swapping, by the computer system, the first debt structure with the second debt structure.

11. The computer program product of claim 10, wherein the first debt structure is a first bond and wherein the second debt structure is a second bond.

12. The computer program product of claim 11, wherein the triggering event is a change in rating of the first bond, and wherein the second bond has a rating of the first bond prior to the change in rating of the first bond.

13. The computer program product of claim 12, wherein the method further comprises offering, by the computer system, a choice of bonds to the first party to choose from to become the second bond.

14. The computer program product of claim 11, wherein the triggering event is the death of the first party and the value of the first bond at the time of death being less than a predetermined value, and wherein the second debt structure has a value amounting to at least the predetermined value.

15. The computer program product of claim 10, wherein the triggering event is an event selected from the group consisting of:
a change in rating of the first debt structure;
the death of the first party;
a reduction in value of the first debt structure to a predetermined value; and
a lack of increase in value of the first debt structure over time from the date of the contract being executed.

16. The computer program product of claim 10, wherein the first party is a buyer and wherein the second party is not a seller of the first debt structure, further comprising separating the right of the buyer from the first debt structure such that the contract is owned by neither the buyer nor the seller.

17. The computer program product of claim 10, wherein the triggering event occurs at least partially at the discretion of the buyer.

18. The computer program product of claim 10, wherein the second party is an original seller of the first debt structure.

19. A computer system comprising a computer processor coupled to a computer-readable memory unit, said memory unit comprising instructions that when executed by the computer processor implements a method comprising:
analyzing, by the computer system, a contract, the contract including:
a triggering event associated with a first debt structure; and
a right to a first party upon the occurrence of the triggering event to swap the first debt structure with a second debt structure;
determining, by the computer system, that the triggering event occurred; and
swapping, by the computer system, the first debt structure with the second debt structure.

20. The computer system of claim 19, wherein the first debt structure is a first bond and wherein the second structure is a second bond.
